(19) United States
(12) Patent Application Publication
(10) Pub. No.: US 2014/0225705 A1
(43) Pub. Date: Aug. 14, 2014

(54) FLAT INDUCTOR AND METHODS OF MANUFACTURING AND USING THE SAME

(71) Applicant: SAMSUNG ELECTRONICS CO., LTD, Suwon-si (KR)

(72) Inventors: Ki Young KIM, Yongin-si (KR); Keum Su SONG, Seoul (KR); Mikhail Nikolaevich MAKURIN, Arkhangelsk (RU); Nikolay Nikolaevich OLYUNIN, Perm (RU); Vladimir Mihailovich PARFENYEV, Himki (RU)

(73) Assignee: SAMSUNG ELECTRONICS CO., LTD, Suwon-si (KR)

(21) Appl. No.: 14/177,524

(22) Filed: Feb. 11, 2014

(30) Foreign Application Priority Data
Feb. 11, 2013 (RU) 2013105647
Dec. 23, 2013 (KR) 10-2013-0161272

(51) Int. Cl. H01F 27/28

(52) U.S. Cl. CPC H01F 27/2871
USPC 336/232

(57) ABSTRACT

A flat inductor, a method of manufacturing a flat inductor, and a circuit including a flat inductor are provided. A flat inductor includes a coil having a predetermined thickness, and a first magnetic medium layer disposed along a side surface of the coil, the first magnetic medium layer having a first width and a first height.

### CROSS-REFERENCE TO RELATED APPLICATION(S)

This application claims the benefit under 35 USC 119(a) of Russian Patent Application No. 2013105647 filed on Feb. 11, 2013, in the Russian Federal Service for Intellectual Property, and Korean Patent Application No. 10-2013-0161272, filed on Dec. 23, 2013, in the Korean Intellectual Property Office, the entire disclosures of which are incorporated herein by reference for all purposes.

### BACKGROUND

1. Field

The following description relates to the field of electrotechnics and to a flat inductor with an increased quality (Q)-factor and methods of manufacturing and using the same.

2. Description of Related Art

An inductor refers to a circuit device used to obtain an inductance. In general, an inductor may be manufactured using a coil or a solenoid. A flat inductor may be manufactured using a coil or a metallic pattern in a spirally wound form.

Flat inductors are widely applied to various fields of science and engineering such as, for example, in technology of wireless energy transmission or in high-frequency integrated circuits. Many such applications of inductors demand inductors with the largest possible Q-factor for their successful implementation. In general, a geometrical size and an operating frequency of the inductor may be determined by a predetermined practical application.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a flat inductor includes a coil having a predetermined thickness, and a first magnetic medium layer disposed along a side surface of the coil, the first magnetic medium layer having a first width and a first height.

The coil may have a width that is at least 5 times greater than the predetermined thickness of the coil.

The first magnetic medium layer may be spaced apart from the side surface of the coil by a predetermined distance.

The first height of the first magnetic medium layer may be determined in a direction parallel to the side surface of the coil, and the first width of the first magnetic medium layer may be determined in a direction perpendicular to the side surface of the coil.

A magnetic loss coefficient of the first magnetic medium layer may be less than 1.0×10⁻⁴.

The first height of the first magnetic medium layer may be at least two times greater than the predetermined thickness of the coil.

The first magnetic medium layer may include a ferrite compensator comprising ferrite.

The general aspect of the flat inductor may further include a first ferrite plate, and a second ferrite plate. The first ferrite plate may be disposed on a top surface of the coil, the second ferrite plate may be disposed on a bottom surface of the coil, and the first ferrite plate and the second ferrite plate may include ferrite.

The general aspect of the flat inductor may further include a second magnetic medium layer having a second width and a second height. The coil may have a shape of a concentric cylinder having a predetermined internal radius and a predetermined external radius. The first magnetic medium layer may be disposed on an inner side surface of the coil to surround the inner side surface of the coil, and the second magnetic medium layer may be disposed on an outer side surface of the coil to surround the outer side surface of the coil.

The second width may be substantially equal to the first width. The second height may be substantially equal to the first height. A magnetic loss coefficient of the second magnetic medium layer may be substantially equal to the magnetic loss coefficient of the first magnetic medium layer.

The first magnetic medium layer may be spaced apart from the inner side surface of the coil. The second magnetic medium layer may be spaced apart from the outer side surface of the coil.

The first height may be determined in a direction parallel to the inner side surface of the coil. The second height may be determined in a direction parallel to the outer side surface of the coil. The first width may be determined in a direction perpendicular to the inner side surface of the coil. The second width may be determined in a direction perpendicular to the outer side surface of the coil.

The first width and the second width may be in a range of 5 to 10% of the internal radius.

The general aspect of the flat inductor may further include a first ferrite ring, and a second ferrite ring. The first ferrite ring may be disposed on a top surface of the coil. The second ferrite ring may be disposed on a bottom surface of the coil. The first ferrite ring and the second ferrite ring may include ferrite.

A surface of the first ferrite ring and a surface of the second ferrite ring may have a shape of a concentric circle, and internal radii of the concentric circles may be substantially equal to the internal radius of the concentric cylinder of the coil, and an external radius of the concentric circle may be substantially equal to the external radius of the concentric cylinder.

In another general aspect, a method of manufacturing a flat inductor involves: disposing a magnetic medium layer on a side surface of a coil to surround the side surface of the coil, in which the coil has a width that is at least 5 times greater than a thickness of the coil.

The general aspect of the method may further involve disposing a first ferrite plate on a top surface of the coil, and disposing a second ferrite plate on a bottom surface of the coil. The first ferrite plate and the second ferrite plate may include ferrite.

The coil may have a shape of a concentric cylinder having a predetermined internal radius and a predetermined external radius, and the disposing may involve: disposing a first magnetic medium layer on an inner side surface of the coil to surround the inner side surface of the coil, and disposing a second magnetic medium layer on an outer side surface of the coil to surround the outer side surface of the coil.

The general aspect of the method may further involve disposing a first ferrite ring on a top surface of the coil, and disposing a second ferrite ring on a bottom surface of the coil, and the first ferrite ring and the second ferrite ring may include ferrite.

In yet another general aspect, there is provided a circuit including a flat inductor comprising a coil having a width-to-thickness ratio of 5 or greater, and a magnetic medium layer disposed on a side surface of the coil and surrounding the side surface of the coil, in which the circuit is configured to induce current or generate magnetic field with the flat inductor.

A height of the magnetic medium layer may be at least two times greater than a thickness of the flat coil, and the flat inductor may further include a first ferrite ring and a second ferrite ring disposed on a top surface and a bottom surface of the coil.

A Q-factor of the flat inductor may be 1000 or greater at an operating frequency of 7 MHz.

Other features and aspects will be apparent from the following detailed description, the drawings, and the claims.

### BRIEF DESCRIPTION OF THE DRAWINGS

FIG. 1 is a perspective view illustrating an example of a flat inductor.

FIG. 2 is a graph illustrating a change in a current density of an example of a flat inductor based on a location along the flat inductor.

FIG. 3 is a perspective view illustrating an example of a flat inductor including magnetic medium layers.

FIG. 4 is a graph illustrating a change in a current density of an example of a flat inductor based on a location along the flat inductor.

FIG. 5 is a cross-sectional view illustrating an example of a flat inductor including magnetic medium layers and ferrite rings.

FIG. 6 is a flowchart illustrating an example of a method of manufacturing a flat inductor.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Hereinafter, the term “to dispose” may be used to indicate the same meaning as “to attach” and thus, both terms may be interchangeable.

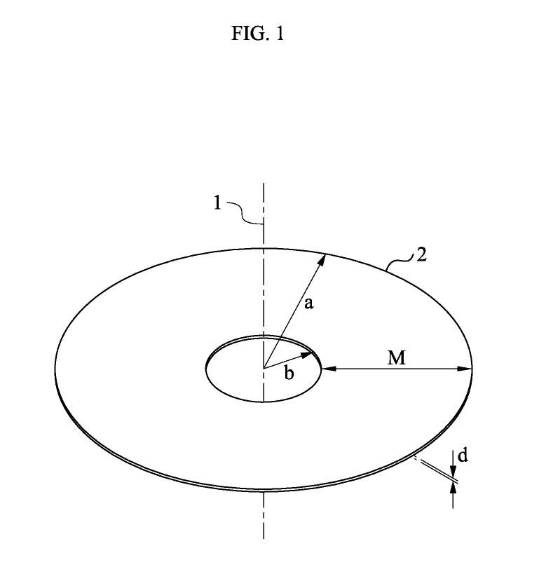

FIG. 1 illustrates an example of a flat inductor.

A quality (Q)-factor of an inductor may be determined based on Equation 1. The Q-factor may correspond to a parameter of the coil.

$$Q = \frac{ω L}{R} \qquad [ Equation 1 ]$$

In Equation 1, the label ω denotes an operating frequency of the inductor, L denotes an inductance of the inductor, and R denotes an effective resistance of the inductor. The effective resistance R of the inductor may be affected by at least one of an ohmic resistance, a convection loss, and a radiation loss of the inductor.

Referring to FIG. 1, the flat inductor 2 includes a coil. The flat inductor 2 may correspond to the coil, or may include additional structures. In this example, an operating frequency, an inductance, and an effective resistance of the flat inductor 2 may correspond to an operating frequency, an inductance, and an effective resistance of the coil, respectively. Referring to FIG. 1, the coil has a predetermined thickness d. In this example, the coil is a flat coil. However, in other examples, the inductor may include different types of coils.

Referring to FIG. 1, the coil of the flat inductor 2 has a shape of a concentric cylinder having a predetermined internal radius and a predetermined external radius. For example, the label ‘b’ denotes the internal radius of the coil of the flat inductor 2. The label ‘a’ denotes the external radius of the coil of the flat inductor 2. The label ‘d’ denotes a thickness of the coil of the flat inductor 2. An axis 1 may correspond to a central axis of the coil of the flat inductor 2. The coil of the flat inductor 2 may be manufactured in a shape of a concentric cylinder. The shape of the concentric cylinder may be formed by bending a straight coil or a flat coil spirally or by cutting out a shape of a concentric disk from a flat substrate or a disk-shaped substrate, for example.

Referring to FIG. 1, the flat inductor 2 includes a flat coil. A flat coil refers to a coil having an elongated cross-section, such as an elliptical, rectangular or polygonal cross-section with an elongated diameter or width in one direction and a shorter diameter or thickness along another direction. In one example, the elongated diameter or width may be at least five (5) times greater than the shorter diameter or thickness. In another example, the elongated diameter or width may be approximately 10-10,000 times the shorter diameter or thickness. In yet another example, the elongated diameter or width may be approximately 50-1,000 times the shorter diameter or thickness of the cross-section of the coil. Referring to FIG. 1, the cross-section of the flat coil has a thickness of d and a width of a−b. For this example, the ratio of the thickness d to the width a−b ranges approximately 50 to 100. However, the flat inductor 2 according to the present description is not limited thereof. For instance, in another example, the cross-section may be elliptical or polygonal, and the ratio between the elongated diameter or width and the shortened diameter or thickness may vary.

In the following descriptions, a quasistatic case defined using Equation 2 may be assumed.

$$\frac{ω}{c} a 1 \qquad [ Equation 2 ]$$

In Equation 2, the label ‘c’ denotes a velocity of light in an ambient environment. A product of the operating frequency of the flat inductor 2 and an external radius of the flat inductor 2 may be an overly small value compared to the velocity of light in the ambient environment. Assuming a quasistatic case, a radiation loss of the flat inductor 2 may be negligible, and the external radius a and the internal radius b of the flat inductor 2 may be substantially greater than a thickness δ of a skin layer.

The thickness d of the flat inductor 2 may be comparable to the thickness 6 of the skin layer. The thickness d of the flat inductor 2 may be a sufficiently small value corresponding to the thickness δ of the skin layer.

For example, a, ω, and δ may be determined based on Equation 3 to Equation 5.

$$\begin{matrix}f = \frac{ω}{2 π} \approx 10 MHz & [ Equation 3 ] \\ a \approx 10 cm & [ Equation 4 ] \\ δ \approx 10 μm & [ Equation 5 ]\end{matrix}$$

Ohmic losses may be reduced by a first method to be within applied approximate values.

At an operating frequency of 10 megahertz (MHz), a loss in the coil may be mainly caused by a skin effect and/or a proximity effect. The skin effect and the proximity effect may induce most current to flow over a metal surface. When most current flows over the metal surface, an effective area of a cross-section of a conductor may be reduced. This, in turn, may increase the effective resistance R. To suppress the increase in the effective resistance R of the coil, litz wires may be used to manufacture the coil. However, a method of manufacturing the coil using litz wires may be ineffective in applications in which the thickness δ of the skin layer corresponds to about 10 micrometers (μm) at the operating frequency of 10 MHz. For example, to reduce an effective resistance of a wire with a diameter of 1 millimeter (mm) to ⅓, about 10⁴ wires with a diameter less than 10 μm may be required.

According to another approach of reducing the effective resistance R of the coil, the effective area of the cross-section of the conductor may be increased. The method may involve manufacturing a conducting wire using mutually isolated thin conducting concentric covers. The conducting concentric covers may be thinner than the thickness of the skin layer. By manufacturing the conducting wire using the conducting concentric covers, an effective resistance of the conductor may be reduced, and a Q-factor of the coil may be increased by approximately three times. In the manufactured conducting wire, a parasitic capacity between the concentric covers may be relatively large. As the parasitic capacity between the concentric covers increases, a natural resonant frequency of a projected inductor may decrease. In such an inductor, a capacitor portion of impedance may be less than an inductive portion. Thus, the inductor may not operate at a frequency greater than the natural resonant frequency, and the applications for the approach is limited to certain applications.

By disposing ferrite elements in immediate proximity to the flat inductor 2, the Q-factor of the flat inductor 2 may increase. The ferrite elements may be etched on a printed circuit and disposed in immediate proximity to the flat inductor 2. In this example, a magnetic flux density and an inductivity of the flat inductor 2 may increase. Thus, the Q-factor of the flat inductor 2 may increase. The inductivity of the flat inductor 2 may correspond to a value proportional to the inductance of the flat inductor 2 or a value of the inductance.

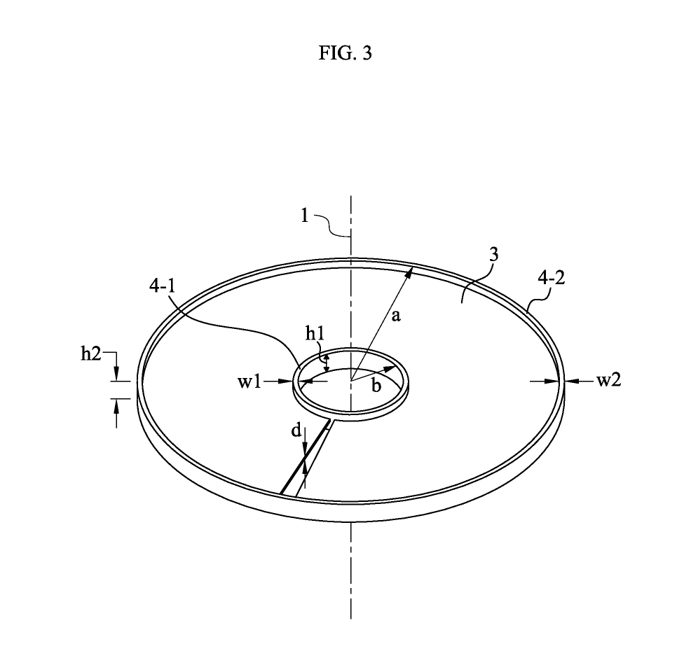

Although the magnetic flux density or the inductivity does not increase, the Q-factor of the flat inductor 2 may increase. A flat inductor having an increased Q-factor without increasing a magnetic flux density or inductivity will be described in detail with reference to FIGS. 3 through 5.

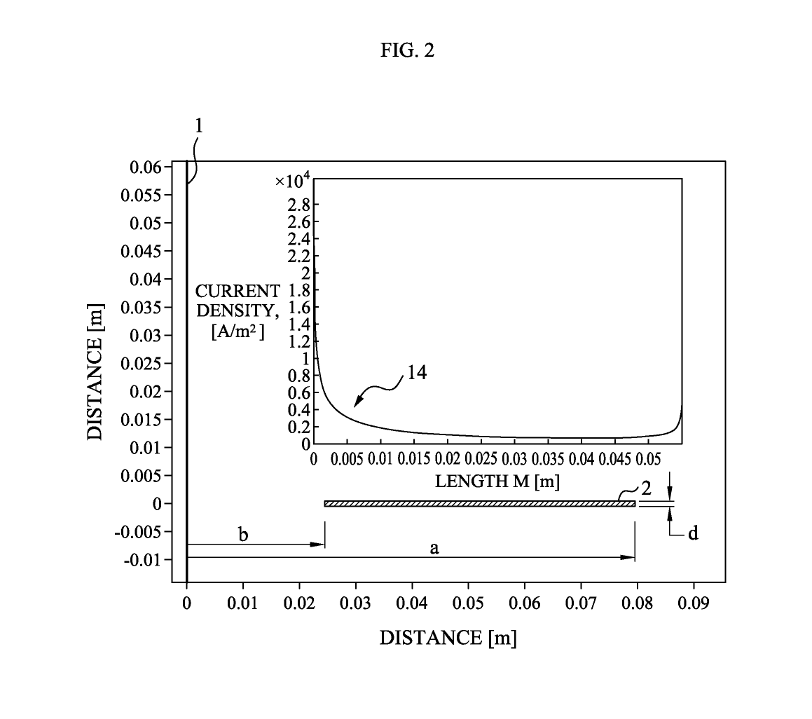

FIG. 2 illustrates a graph indicating the current density of a flat inductor 2 along various locations of the flat inductor 2. The example of flat inductor 2 may have the shape of the flat inductor illustrated in FIG. 1.

Referring to the graph illustrated in the lower right corner of FIG. 2, the shape of the flat inductor 2 may correspond to a portion of a side cross-section of the shape of the concentric cylinder of the flat inductor 2 illustrated in FIG. 1. An axis 1 shown in FIG. 2 corresponds to the axis 1 at the center of the flat inductor 2 illustrated in FIG. 1.

The x-axis at the bottom of the graph and the y-axis at the left of the graph correspond to the dimensions of the flat coil in meters (m). For instance, the length M of the flat coil corresponds to approximately 0.055 m, as indicated by the x-axis. Likewise, the y-axis on the left of the graph illustrates a thickness d of the flat coil to be substantially less than 0.005 m.

A smaller graph illustrating a response curve 14 is enclosed within the big graph. The x-axis of a response curve 14 indicates a location along the width of the flat coil of the flat inductor 2. A value of an x-axis coordinate is measured in meters (m).

A length M of the flat coil corresponds to a value obtained by subtracting an internal radius b from an external radius a of the coil. The x-axis coordinate of “0” corresponds to a location of the flat inductor 2 separated by b from the axis 1.

A y-axis of the response curve 14 indicates current density. The current density may be measured in a unit of amperes per square meter (A/m²).

The response curve 14 illustrates a distribution of current density with respect to various locations along the flat inductor 2. That is, the response curve 14 illustrates the current density along the width of the coil, from a location of the flat inductor 2 separated by a distance corresponding to the internal radius b from the axis 1 to a location of the flat inductor 2 separated by a distance corresponding to the external radius a from the axis 1.

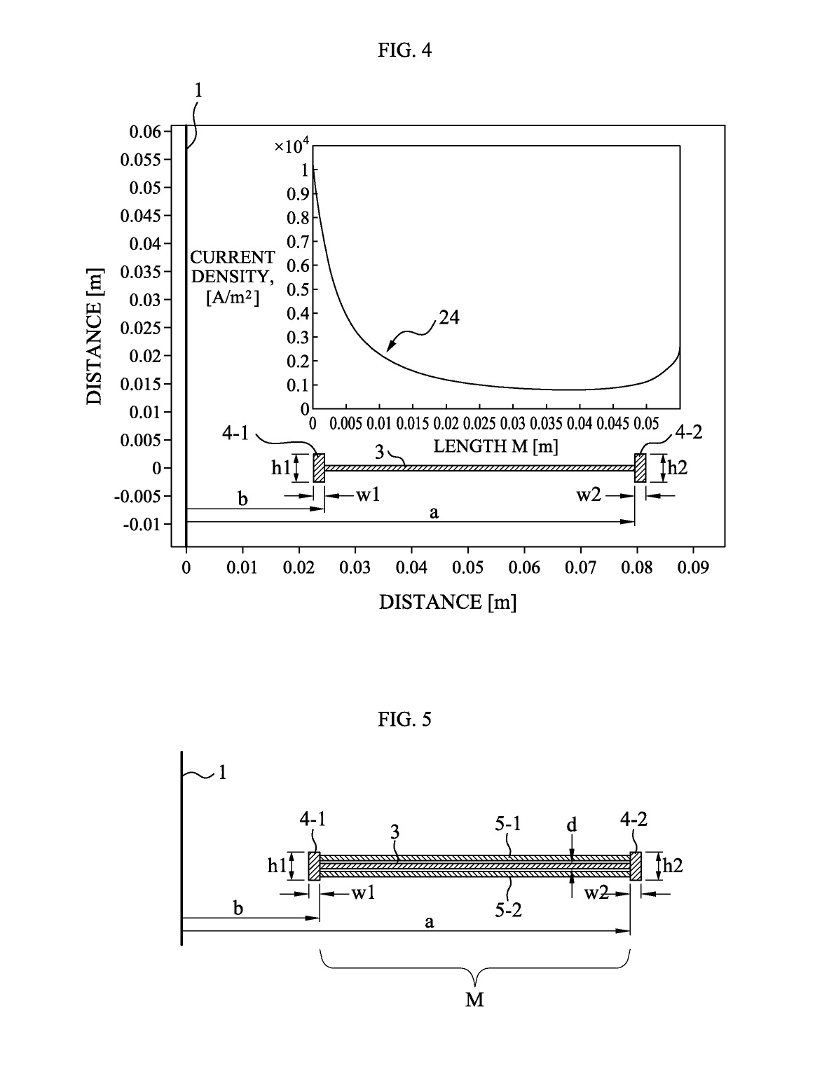

Referring to the response curve 14 of FIG. 2, the current density with respect to the change in the location on the flat inductor 2 may not be uniform, in comparison to a current density of the flat inductor illustrated by the response curve 24 of FIG. 4. A change in a y-axis coordinate with respect to a change in an x-axis coordinate of the response curve 14 may be greater than a change in a y-axis coordinate with respect to a change in an x-axis coordinate of the response curve 24. When the current density or the change in the current density with respect to the change in the location on the flat inductor 2 is not uniform, an effective area of a conductor in which current may flow may be reduced. The effective area may correspond to a cross-section of the conductor. When the effective area of the conductor is reduced, an effective resistance R of the flat inductor may increase. Based on Equation 1 described with reference to FIG. 1, a Q-factor of a flat inductor is inversely proportional to an effective resistance R of the flat inductor. Accordingly, the Q-factor if the flat inductor is decreased when the effective area of the coil is reduced.

The same descriptions provided with reference to FIG. 1 may be applicable and thus, duplicated descriptions will be omitted for conciseness.

FIG. 3 illustrates an example of a flat inductor that includes magnetic medium layers.

In examples to be described with reference to FIGS. 3 through 5, a flat inductor includes magnetic medium layers, and the magnetic medium layers may be configured to redistribute current density along the flat coil. By redistributing the current density, it is possible to reduce an effective resistance R of the flat inductor and to, thus, increase the Q-factor of the flat inductor. As illustrated by Equation 1, by reducing an effective resistance R of the flat inductor, the Q-factor of the flat inductor may be increased.

Hereinafter, a process of reducing an effective resistance R of a flat inductor using magnetic medium layers will be described in detail.

The magnetic medium layers included in the flat inductor may redistribute the current density spatially. By including the magnetic medium layers in the flat inductor, it is possible to increase a magnitude of a magnetic field in a vicinity of locations on the coil having a maximum current density. According to Lenz law, as a change in strength of a magnetic field increases, a reactance voltage that prevents the current flow in a vicinity of the inductor may increase. The current density may be redistributed as the reactance voltage increases. By redistributing the current density, the effective area in which current flows may increase, and an ohmic loss of the flat inductor may decrease.

Thus, the magnetic medium layers included in the flat inductor may change a spatial distribution of the magnetic field. When the spatial distribution of the magnetic field is changed, the inductivity of the flat inductor may increase by a corresponding degree. When the inductivity of the flat inductor increases, the inductance of the flat inductor may increase. Thus, based on Equation 1, the Q-factor of the flat inductor may be increased.

Referring to FIG. 3, a flat inductor that includes two magnetic medium layers is illustrated.

The flat inductor includes a coil 3, and two magnetic medium layers. The coil 3 may have the structure and shape of the flat inductor 2, as described with reference to FIGS. 1 and 2. Accordingly, descriptions that are repetitive have been omitted for conciseness. The flat inductor of FIG. 3 may correspond to the flat inductor 2 that additionally includes magnetic medium layers.

The coil 3 may be provided in a shape of a concentric cylinder having a predetermined internal radius b and a predetermined external radius a. The coil 3 may be a flat coil. The label ‘b’ in FIG. 3 denotes the internal radius of the coil 3, and the label ‘a’ denotes the external radius of the coil 3. The coil 3 may be manufactured in a shape of a concentric cylinder. The shape of the concentric cylinder may be formed by bending a straight coil or a flat coil spirally, or by cutting out the concentric cylinder shape from a flat substrate or a disk-shaped substrate, for example.

In contrast to FIG. 3, in another example, the coil 3 may have a shape of a polygonal prism. For example, the coil 3 may have a shape of a concentric polygonal prism. The shape of the concentric polygonal prism may be formed by an inner polygonal prism and an outer polygonal prism having the same center. For example, the coil 3 may be provided in a shape of a concentric tetragonal prism, and the shape of the concentric tetragonal prism may be formed by bending a straight coil or a flat coil spirally.

Referring to FIG. 3, the flat inductor includes the coil 3 and a first magnetic medium layer 4-1. The coil 3 may have a predetermined thickness. For example, the label ‘d’ denotes the predetermined thickness of the coil 3. While a slit is provided to illustrate the thickness d, the flat inductor may not include such a slit.

The first magnetic medium layer 4-1 may have a first width, a first height, and a first magnetic loss coefficient.

The first width, the first height, and the first magnetic loss coefficient may correspond to unique values of the first magnetic medium layer 4-1. For example, the label ‘w1’ denotes the first width, and the label ‘h1’ denotes the first height.

A geometrical structure of the first magnetic medium layer 4-1 may be determined based on various parameters. The various parameters may include at least one of an operating frequency of the flat inductor, a property of the first magnetic medium layer 4-1, and a geometrical size of the flat inductor.

An optimal size of the first magnetic medium layer 4-1 may be calculated individually using numerical modeling for a flat inductor to be manufactured. For example, the first height h1 and the first width w1 of the first magnetic medium layer 4-1 may be selected from values that may increase an inductivity of the coil 3 and reduce an effective resistance of the flat inductor as the inductivity increases.

The first magnetic loss coefficient may correspond to a value determined based on an element and/or a material to be used to configure the first magnetic medium layer 4-1. For example, the first magnetic loss coefficient may be a value less than 1.0×10⁻⁴. In this example, an element and/or a material having a magnetic loss coefficient less than 1.0×10⁻⁴ may be selected as the element and/or the material to be used to configure the first magnetic medium layer 4-1. An ideal value of the first magnetic loss coefficient may be “0”.

The first magnetic medium layer 4-1 may include ferrite. The first magnetic medium layer 4-1 may correspond to a ferrite compensator, a ferrite substrate, or a ferrite lamina including ferrite.

Ferrite may refer to a magnetic material including an iron compound. The iron compound included in ferrite may correspond to iron oxide.

The first height h1 of the first magnetic medium layer 4-1 may correspond to a length h1 of a first surface of a magnetic medium layer along an inner side surface of the coil 3. The inner side surface may correspond to a side surface of the coil 3 on which the first magnetic medium layer 4-1 of the coil 3 is disposed. The first surface may be parallel to a plane or a direction for measuring the thickness of the coil 3. The length of the first surface may be greater than the thickness d of the coil 3.

The first height h1 of the first magnetic medium layer 4-1 and the thickness d of the coil 3 may be adjusted for the Q-factor of the flat inductor to be maximized. For example, the first height h1 may be at least two times greater than the thickness d of the coil 3. In this example, h1/d may be greater than or equal to “2”.

The first width w1 of the first magnetic medium layer 4-1 may correspond to a length of the first magnetic medium layer 4-1 disposed perpendicular to the first surface. The first width w1 may correspond to a thickness w1 of the first magnetic medium layer 4-1 disposed perpendicular to a surface of the first magnetic medium layer 4-1 corresponding to the inner side surface of the coil 3 on which the first magnetic medium layer 4-1 is disposed.

The first magnetic medium layer 4-1 may be disposed on a side surface of the coil 3 to surround the side surface of the coil 3. The side surface of the coil 3 may correspond to a surface parallel to the axis 1 of the coil 3, among surfaces of the coil 3.

The first magnetic medium layer 4-1 may be disposed adjacent to the side surface of the coil 3. The first magnetic medium layer 4-1 may be attached to the side surface of the coil 3. The first magnetic medium layer 4-1 may also be disposed at a location separated by a predetermined distance from the side surface of the coil 3. The predetermined distance between the first magnetic medium layer 4-1 and the coil 3 may be negligible, compared to the internal radius b of the coil 3 and/or the predetermined width w1 of the first magnetic medium layer 4-1. For example, the predetermined distance may be 0.

In a case of the coil 3 provided in a shape of a concentric cylinder, the flat inductor further includes a second magnetic medium layer 4-2 having a second width w2, a second height h2, and a second magnetic loss coefficient.

The second width w2 of the second magnetic medium layer 4-2 may be identical to the first width w1 of the first magnetic medium layer 4-1. The second height h2 of the second magnetic medium layer 4-2 may be identical to the first height h1 of the first magnetic medium layer 4-1. The second magnetic loss coefficient of the second magnetic medium layer 4-2 may be identical to the first magnetic loss coefficient of the first magnetic medium layer 4-1.

Magnetic properties and characteristics of the second magnetic medium layer 4-2 may be identical to magnetic properties and characteristics of the first magnetic medium layer 4-1. For example, the second magnetic medium layer 4-2 and the first magnetic medium layer 4-1 may include the same ferrite.

Accordingly, the descriptions on the first magnetic medium layer 4-1 may be applied to the second magnetic medium layer 4-2 and thus, duplicated descriptions will be omitted for conciseness.

The first magnetic medium layer 4-1 may be disposed on an inner side surface of the coil 3 to surround the inner side surface of the coil 3. The inner side surface of the coil 3 may correspond to a side surface of a first cylinder. The first cylinder may include, as a base, an inner circle on a surface of a concentric circle of the coil 3 provided in the shape of the concentric cylinder. A diameter of the inner circle may correspond to an internal diameter of the concentric circle of the coil 3. The first magnetic medium layer 4-1 may be disposed adjacent to the inner side surface of the coil 3.

The second magnetic medium layer 4-2 may be disposed on an outer side surface of the coil 3 to surround the outer side surface of the coil 3. The outer side surface of the coil 3 may correspond to a side surface of a second cylinder. The second cylinder may include, as a base, an outer circle on the surface of the concentric circle of the coil 3 provided in the shape of the concentric cylinder. A diameter of the outer circle may correspond to an external diameter of the concentric circle of the coil 3. The second magnetic medium layer 4-2 may be disposed adjacent to the outer side surface of the coil 3.

The first height h1 of the first magnetic medium layer 4-1 may correspond to a length of a first surface of the first magnetic medium layer 4-1 corresponding to the inner side surface of the coil 3. The length of the first surface may correspond to the height h1 of the first magnetic medium layer 4-1. The height h1 may be measured in a direction parallel to a direction of measuring the thickness d of the coil 3.

The first width w1 of the first magnetic medium layer 4-1 may correspond to a first thickness of the first magnetic medium layer 4-1 disposed perpendicular to the first surface.

The second height h2 of the second magnetic medium layer 4-2 may correspond to a length of a second surface of the second magnetic medium layer 4-2 corresponding to the outer side surface of the coil 3. The length of the second surface may correspond to the height h2 of the second magnetic medium layer 4-2. The height h2 may be measured in a direction parallel to the direction of measuring the thickness d of the coil 3.

The second width w2 of the second magnetic medium layer 4-2 may correspond to a second thickness of the second magnetic medium layer 4-2 disposed perpendicular to the second surface.

At least one of the first width w1 of the first magnetic medium layer 4-1, the second width w2 of the second magnetic medium layer 4-2, the internal radius b of the coil 3, and the external radius a of the coil 3 may be adjusted for the Q-factor of the flat inductor to be maximized. For example, the first width w1 of the first magnetic medium layer 4-1 and the second width w2 of the second magnetic medium layer 4-2 may be in a range of 5 to 10% of the internal radius b of the coil 3.

The first magnetic loss coefficient of the first magnetic medium layer 4-1 and the second magnetic loss coefficient of the second magnetic medium layer 4-2 may be identical to a magnetic loss coefficient of ferrite included in the first magnetic medium layer 4-1 and the second magnetic medium layer 4-2.

A magnetic loss coefficient k of a magnetic medium layer may be defined by Equation 6.

$$\frac{{μ}^{″}}{{( {μ}^{′} )}^{2}} = k \qquad [ Equation 6 ]$$

In Equation 6, the label μ′ denotes a real part of a permeability μ of the magnetic medium layer. The label μ″ denotes an imaginary part of the permeability μ of the magnetic medium layer.

As described above, when the first height h1 of the first magnetic medium layer 4-1 and the second height h2 of the second magnetic medium layer 4-2 are at least two times greater than the thickness d of the coil 3, and the first width w1 of the first magnetic medium layer 4-1 and the second width w2 of the second magnetic medium layer 4-2 are in the range of 5 to 10% of the internal radius b of the coil 3, magnetic loss coefficients k of the first magnetic medium layer 4-1 and the second magnetic medium layer 4-2 may be determined to be about 1.0×10⁻⁴. The Q-factor of the flat inductor may increase up to two times, compared to the Q-factor of the flat inductor 2 of FIG. 2.

In contrast to FIG. 3, in another example, the first magnetic medium layer 4-1 and the second magnetic medium layer 4-2 may be disposed at locations separated by predetermined distances from the inner side surface and the outer side surface of the coil 3, respectively. For example, the predetermined distances may be 0.

In an ambient environment, the magnetic loss coefficient of ferrite included in the first magnetic medium layer 4-1 and the second magnetic medium layer 4-2 may not correspond to “0”. Ferrite included in each of the first magnetic medium layer 4-1 and the second magnetic medium layer 4-2 may cause a nonzero loss in the flat inductor. The loss caused by ferrite may increase an effective resistance R of the flat inductor.

When the magnetic loss of ferrite is greater than a predetermined value, the Q-factor of the flat inductor including the first magnetic medium layer 4-1 and the second magnetic medium layer 4-2 may be less than a Q-factor of a flat inductor not including magnetic medium layers. For example, when a Q-factor of ferrite determined by the magnetic loss of ferrite is comparable to or greater than the Q-factor of the coil 3, a considerable amount of energy of a magnetic field of the coil 3 may be concentrated in ferrite. In this example, the Q-factor of the flat inductor including the first magnetic medium layer 4-1 and/or the second magnetic medium layer 4-2 may be lower than the Q-factor of the flat inductor not including the magnetic medium layers.

Each of the first magnetic medium layer 4-1 and the second magnetic medium layer 4-2 may include ferrite having a magnetic loss coefficient less than or equal to a predetermined value. For example, the magnetic loss coefficient of ferrite included in each of the first magnetic medium layer 4-1 and the second magnetic medium layer 4-2 may be determined among predetermined values that may reduce the effective resistance of the flat inductor including the first magnetic medium layer 4-1 and the second magnetic medium layer 4-1 to be less than an effective resistance of the coil 3.

In an example in which the first magnetic medium layer 4-1 and the second magnetic medium layer 4-2 are disposed directly on the coil 3, a change in the effective resistance of the coil 3 may be negative.

According to one example, an approach of increasing a Q-factor may involve a method of reducing an ohmic resistance while other solutions may involve increasing an inductivity L of a coil.

With this approach, it is possible to increase the Q-factor of the flat inductor to about two times the Q-factor of a similar flat inductor. In addition, the substantial implementation of the flat inductor may be easier than the implementation of other similar flat inductors.

Other methods of increasing a Q-factor of a flat inductor may be applied to the flat inductor including the magnetic medium layers. By applying such methods to the flat inductor, the flat inductor may have a greater Q-factor.

The Q-factor of the flat inductor may increase through various mechanisms. The flat inductor may include a more moderate amount of a magnetic material than the other similar flat inductors. Despite the use of the more moderate amount of the magnetic material, the flat inductor may have a greater Q-factor than the other similar flat inductors. The flat inductor may be more efficient than the other similar flat inductors in an aspect of plane geometry.

The flat inductor may be capable of operating in a higher frequency band than the other similar flat inductors. For example, the flat inductor may be operable in a frequency band ranging between 1 MHz and 20 MHz.

The descriptions provided with reference to FIGS. 1 and 2 may be applied hereto and thus, duplicated descriptions will be omitted for conciseness.

FIG. 4 illustrates a graph indicating the current density at a coil of a flat inductor based on various locations along the width of the coil. In this example, the flat inductor includes magnetic medium layers. For example, the structure and shape of the flat inductor may correspond to the flat inductor illustrated in FIG. 3.

Referring to FIG. 4, the cross-section of the flat inductor illustrated at the bottom may correspond to a portion of a side cross-section of the flat inductor of FIG. 3. The flat inductor includes the coil 3 provided in a shape of a concentric cylinder, the first magnetic medium layer 4-1, and the second magnetic medium layer 4-2. An axis 1 may correspond to a central axis of the flat inductor.

An x-axis of a response curve 24 indicates a location along the coil of the flat inductor. A value of an x-axis coordinate may be measured in a unit of m. A length M of the flat inductor corresponds to a value obtained by subtracting an internal radius b from an external radius a of the flat inductor. An x-axis coordinate of “0” may correspond to a location of the flat inductor 2 of FIG. 2 separated by a distance corresponding to the internal radius b from the axis 1.

A y-axis of the response curve 14 indicates current density. The current density may be measured in a unit of A/m². The response curve 24 illustrates a distribution of the current density with respect to various locations along the flat inductor. That is, the response curve 24 illustrates current density with respect to various locations along a width of the coil 3, from a location of the flat inductor separated by a distance corresponding to the internal radius b from the axis 1 to a location of the flat inductor 2 separated by a distance corresponding to the external radius a from the axis 1.

In a flat inductor that does not include the first magnetic medium layer 4-1 and the second magnetic medium layer 4-2, the current distribution may reach an equilibrium current distribution due to sharp peaks of the current density at a location close to an edge of the coil 3. The sharp peaks of the current density may occur at a location close to an inner side surface of the coil 3 and at a location close to an outer side surface of the coil 3. The sharp peaks of the current density may cause a normal component of a magnetic field inevitably. When the current distribution reaches the equilibrium current distribution, the normal component of the magnetic field on the surface of the coil 3 may correspond to “0”.

In a flat inductor that includes a first magnetic medium layer 4-1 and a second magnetic medium layer 4-2, a magnitude of the magnetic field may increase based on an intensity of magnetization, and levels of peaks of the current density occurring at the location close to the edge of the coil 3 may decrease. In addition, in the absence of a value of the normal component of the magnetic field, widths of the peaks of the current density occurring at the location close to the edge of the coil 3 may increase. The distribution of the current density with respect to the change in the location on the flat inductor illustrated in the response curve 24 may be more uniform than the distribution of the current density illustrated in the response curve 14 of FIG. 2.

In the descriptions on the response curve 24, the axes of the response curve 24, and the flat inductor, the first width w1 of the first magnetic medium layer 4-1 and the second width w2 of the second magnetic medium layer 4-2 may be considered additionally. For example, the length M of the flat inductor may correspond to a value obtained by adding the first width w1 of the first magnetic medium layer 4-1 and the second width w2 of the second magnetic medium layer 4-2 to the value obtained by subtracting the internal radius b from the external radius a.

The descriptions provided with reference to FIGS. 1 and 3 may be applied hereto and thus, duplicated descriptions will be omitted for conciseness.

FIG. 5 illustrates an example of a flat inductor including magnetic medium layers and ferrite rings.

In FIG. 5, an example of a flat inductor in which ferrite plates or ferrite rings are added to the coil are described. The coil and the magnetic medium layers may substantially conform to the structure and shape of the coil and magnetic medium layers described with reference to FIGS. 3 and 4. Thus, repetitive descriptions will be omitted for conciseness.

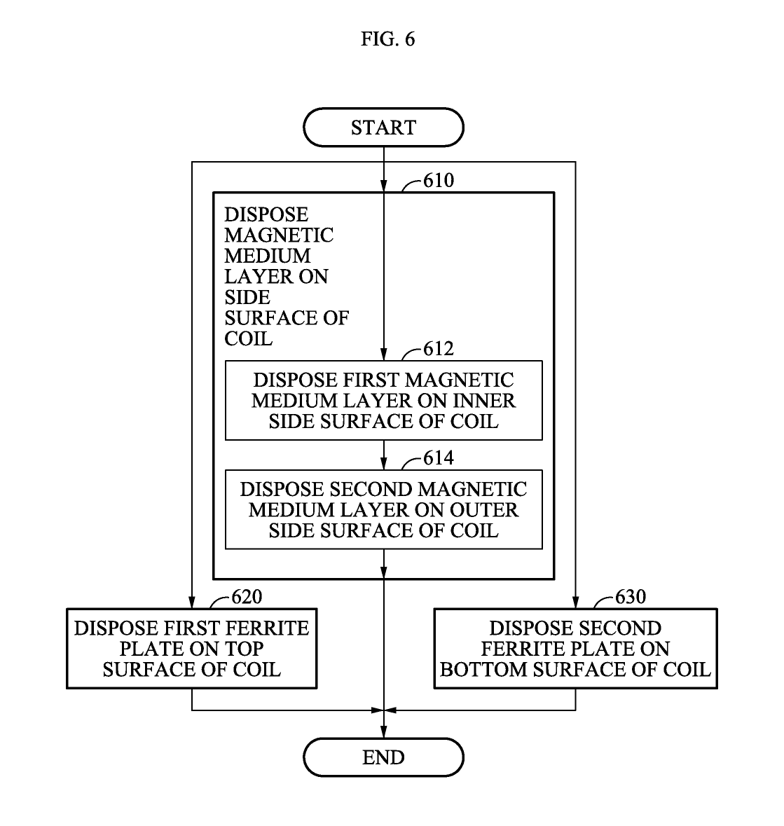

The flat inductor illustrated in FIG. 6 includes a first ferrite plate 5-1 and a second ferrite plate 5-2. The term “ferrite plate” may be used to indicate the same meaning as “ferrite lamina” or “ferrite ring”.

The first ferrite plate 5-1 may be disposed on a top surface of the coil 3.

The second ferrite plate 5-2 may be disposed on a bottom surface of the coil 3.

The top surface and the bottom surface of the coil 3 may correspond to surfaces perpendicular to a side surface of the coil 3, among surfaces of the coil 3. A plane on which the top surface is present may be parallel to a plane on which the bottom surface is present.

The first ferrite plate 5-1 and the second ferrite plate 5-2 may include ferrite. Ferrite included in the first ferrite plate 5-1 and the second ferrite plate 5-2 may be identical to ferrite included in the first magnetic medium layer 4-1 and the second magnetic medium layer 4-2.

Shapes of surfaces of the first ferrite plate 5-1 and the second ferrite plate 5-2 may be identical to shapes of the top surface and the bottom surface of the coil 3, respectively.

Sizes of the surfaces of the first ferrite plate 5-1 and the second ferrite plate 5-2 may be identical to sizes of the top surface and the bottom surface of the coil 3, respectively.

In one example, the first ferrite plate 5-1 and the second ferrite plate 5-2 may be disposed at locations separated by predetermined distances from the top surface and the bottom surface of the coil 3, respectively. The distance between the first ferrite plate 5-1 and the top surface may be negligible, compared to the internal radius b of the coil 3. The distance between the first ferrite plate 5-1 and the top surface may be negligible, compared to widths w1, w2 of the first magnetic medium layer 4-1 and the second magnetic medium layer 4-2. The distance between the second ferrite plate 5-2 and the bottom surface may be negligible, in comparison to the internal radius b of the coil 3. The distance between the second ferrite plate 5-2 and the bottom surface may be negligible, in comparison to the widths w1, w2 of the first magnetic medium layer 4-1 and the second magnetic medium layer 4-2.

The illustrated flat inductor may correspond to a portion of a side cross-section of the flat inductor provided in a shape of a concentric cylinder described with reference to FIGS. 3 and 4. A length of the coil 3 may correspond to a value obtained by subtracting the internal radius b from the external radius a (a−b).

The flat inductor may include a first ferrite ring and a second ferrite ring. The first ferrite ring and the second ferrite ring may correspond to the first ferrite plate 5-1 and the second ferrite plate 5-2, respectively. Thus, duplicated descriptions will be omitted herein for conciseness.

Hereinafter, the first ferrite ring may be described using the same reference numeral as the first ferrite plate 5-1, and the second ferrite ring may be described using the same reference numeral as the second ferrite plate 5-2.

The first ferrite ring 5-1 may be disposed on a top surface of the coil 3.

The second ferrite ring 5-2 may be disposed on a bottom surface of the coil 3.

A surface of the first ferrite ring 5-1 and a surface of the second ferrite ring may be provided in a shape of a concentric circle. The surface of the first ferrite ring 5-1 and the surface of the second ferrite ring 5-2 may correspond to the top surface and the bottom surface of the coil 3, respectively.

Shapes of the surfaces of the first ferrite ring 5-1 and the second ferrite ring 5-2 may be identical to shapes of the top surface and the bottom surface of the coil 3, respectively.

Sizes of the surfaces of the first ferrite ring 5-1 and the second ferrite ring 5-2 may be identical to sizes of the top surface and the bottom surface of the coil 3, respectively.

An internal radius of the concentric circle of the ferrite ring 5-1 or 5-2 may be identical to the internal radius of the concentric cylinder of the coil 3. An external radius of the concentric circle of the ferrite ring 5-1 or 5-2 may be identical to the external radius of the concentric cylinder of the coil 3.

The first ferrite ring 5-1 and the second ferrite ring 5-2 may include ferrite.

When the first ferrite ring 5-1 and the second ferrite ring 5-2 are disposed in the flat inductor, an inductivity or an inductance of the flat inductor may increase.

A Q-factor of the flat inductor including the first ferrite ring 5-1 and the second ferrite ring 5-2 may be less than the Q-factor of the flat inductor described with reference to FIGS. 3 and 4.

Table 1 lists calculated parameters of the flat inductors described with reference to FIGS. 1, 3, and 5 at an operating frequency of 7 MHz. The same ferrite may be used for the flat inductors described with reference to FIGS. 1, 3, and 5. A permeability of ferrite may correspond to 30, and a magnetic dissipation factor may correspond to 0.003. The permeability may be measured in a unit of henries per meter (H/m).

TABLE 1

| | Inductivity, | |
|---|---|---|
| Flat inductor | Conditional unit | Q-factor |
| FIG. 1 | 1 | 685 |
| FIG. 3 | 1.13 | 1457 |
| FIG. 5 | 2.47 | 523 |

The flat inductors may be used as a flat inductor with a high Q-factor that is widely used in science and engineering. The flat inductors may be used as a basic inductor to implement a flat inductor with a high Q-factor that is widely used in science and engineering.

The descriptions provided with reference to FIGS. 1 and 4 may be applied hereto and thus, duplicated descriptions will be omitted for conciseness.

FIG. 6 illustrates an example of a method of manufacturing a flat inductor.

Referring to FIG. 6, in 610, at least one magnetic medium layer is disposed on a side surface of a coil to surround the side surface of the coil.

The magnetic medium layer may have a predetermined width, a predetermined height, and a predetermined magnetic loss coefficient.

The coil may be provided in a shape of a concentric cylinder having an internal radius and an external radius. The coil may correspond to the coil 3 described with reference to FIG. 3.

Operation 610 includes operation 612 and operation 614.

In 612, a first magnetic medium layer is disposed on an inner side surface of the coil to surround the inner side surface of the coil. The first magnetic medium layer may include a first width w1, a first height h1, and a first magnetic loss coefficient.

In 614, a second magnetic medium layer is disposed on an outer side surface of the coil to surround the outer side surface of the coil. The second magnetic medium layer may include a second width w2, a second height h2, and a second magnetic loss coefficient. While both a first magnetic medium layer and a second magnetic medium layer are disposed in this example, in another example, only one magnetic medium layer may be disposed, or a stack of magnetic medium layers may be disposed with a stack of coil. Further, the first width w1 and the second width w2 may be the same or may differ in value. Likewise, the first height h1 and the second height h2 may be the same or may differ in value.

In 620, a first ferrite plate is disposed on a top surface of the coil.

In 630, a second ferrite plate is disposed on a bottom surface of the coil.

The first ferrite plate and the second ferrite plate may include ferrite.

Operations 610, 620, and 630 may be performed in parallel or in sequence. That is, the ferrite plates may be disposed before the magnetic medium layers, or the magnetic medium layers may be disposed before the ferrite plates. In another example, the ferrite plates and the magnetic medium layers may be disposed simultaneously or in alternating orders, one plate and layer at a time.

The descriptions provided with reference to FIGS. 1 and 5 may be applied hereto and thus, duplicated descriptions will be omitted for conciseness.

A flat inductor as described above may be used in a circuit to induce electric current or to generate magnetic field. For example, exposing a flat inductor to a magnetic field induces electric current inside its coil, and applying voltage to the flat inductor causes magnetic field to be generated around the flat inductor. According to another method of using the flat inductor, the flat inductor may be further used to generate resonance in a resonance circuit.

According to one example of a method of using a flat inductor, a flat inductor as described above may be used in a circuit to induce current or to generate magnetic field. The flat inductor may include a coil having a width-to-thickness ratio of 5 or greater, and a magnetic medium layer disposed on a side surface of the coil and surrounding the side surface of the coil. A first ferrite ring and a second ferrite ring may be disposed on a top surface and a bottom surface of the coil. A Q-factor of the flat inductor may be 500 or greater.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, optical data storage devices. Also, functional programs, codes, and code segments that accomplish the examples disclosed herein can be easily construed by programmers skilled in the art to which the examples pertain based on and using the flow diagrams and block diagrams of the figures and their corresponding descriptions as provided herein.

As a non-exhaustive illustration only, a terminal or device described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A flat inductor comprising:
a coil having a predetermined thickness; and
a first magnetic medium layer disposed along a side surface of the coil, the first magnetic medium layer having a first width and a first height.

2. The flat inductor of claim 1, wherein the coil has a width that is at least 5 times greater than the predetermined thickness of the coil.

3. The flat inductor of claim 1, wherein the first magnetic medium layer is spaced apart from the side surface of the coil by a predetermined distance.

4. The flat inductor of claim 1, wherein:
the first height of the first magnetic medium layer is determined in a direction parallel to the side surface of the coil, and
the first width of the first magnetic medium layer is determined in a direction perpendicular to the side surface of the coil.

5. The flat inductor of claim 1, wherein a magnetic loss coefficient of the first magnetic medium layer is less than 1.0×10⁻⁴.

6. The flat inductor of claim 1, wherein the first height of the first magnetic medium layer is at least two times greater than the predetermined thickness of the coil.

7. The flat inductor of claim 1, wherein the first magnetic medium layer comprises a ferrite compensator comprising ferrite.

8. The flat inductor of claim 1, further comprising:
a first ferrite plate; and
a second ferrite plate,
wherein the first ferrite plate is disposed on a top surface of the coil,
the second ferrite plate is disposed on a bottom surface of the coil, and
the first ferrite plate and the second ferrite plate comprise ferrite.

9. The flat inductor of claim 1, further comprising:
a second magnetic medium layer having a second width and a second height,
wherein the coil has a shape of a concentric cylinder having a predetermined internal radius and a predetermined external radius,
the first magnetic medium layer is disposed on an inner side surface of the coil to surround the inner side surface of the coil, and
the second magnetic medium layer is disposed on an outer side surface of the coil to surround the outer side surface of the coil.

10. The flat inductor of claim 9, wherein:
the second width is substantially equal to the first width,
the second height is substantially equal to the first height, and
a magnetic loss coefficient of the second magnetic medium layer is substantially equal to a magnetic loss coefficient of the first magnetic medium layer.

11. The flat inductor of claim 9, wherein:
the first magnetic medium layer is spaced apart from the inner side surface of the coil by a first predetermined distance, and
the second magnetic medium layer is spaced apart from the outer side surface of the coil by a second predetermined distance.

12. The flat inductor of claim 9, wherein:
the first height is determined in a direction parallel to the inner side surface of the coil,
the second height is determined in a direction parallel to the outer side surface of the coil,
the first width is determined in a direction perpendicular to the inner side surface of the coil, and
the second width is determined in a direction perpendicular to the outer side surface of the coil.

13. The flat inductor of claim 9, wherein the first width and the second width are in a range of 5 to 10% of the internal radius.

14. The flat inductor of claim 9, further comprising:
a first ferrite ring; and
a second ferrite ring,
wherein the first ferrite ring is disposed on a top surface of the coil,
the second ferrite ring is disposed on a bottom surface of the coil, and
the first ferrite ring and the second ferrite ring comprise ferrite.

15. The flat inductor of claim 14, wherein:
a surface of the first ferrite ring and a surface of the second ferrite ring have a shape of a concentric circle, and
internal radii of the concentric circles are substantially equal to the internal radius of the concentric cylinder of the coil, and an external radius of the concentric circle is substantially equal to the external radius of the concentric cylinder.

16. A method of manufacturing a flat inductor, the method comprising:
disposing a magnetic medium layer on a side surface of a coil to surround the side surface of the coil.

17. The method of claim 16, further comprising:
disposing a first ferrite plate on a top surface of the coil; and
disposing a second ferrite plate on a bottom surface of the coil,
wherein the first ferrite plate and the second ferrite plate comprise ferrite.

18. The method of claim 16, wherein the coil has a shape of a concentric cylinder having a predetermined internal radius and a predetermined external radius,
wherein the disposing comprises:
disposing a first magnetic medium layer on an inner side surface of the coil to surround the inner side surface of the coil, and
disposing a second magnetic medium layer on an outer side surface of the coil to surround the outer side surface of the coil.

19. The method of claim 18, further comprising:
disposing a first ferrite ring on a top surface of the coil; and
disposing a second ferrite ring on a bottom surface of the coil,
wherein the first ferrite ring and the second ferrite ring comprise ferrite.

20. A circuit comprising:
a flat inductor comprising a coil, and a magnetic medium layer disposed on a side surface of the coil and surrounding the side surface of the coil,
wherein the circuit is configured to induce current or generate magnetic field with the flat inductor.
